(19) United States
(12) Patent Application Publication
(10) Pub. No.: US 2018/0302874 A1
(43) Pub. Date: Oct. 18, 2018

(54) POSITIONING METHOD AND APPARATUS, AND TERMINAL

(71) Applicant: HUAWEI TECHNOLOGIES CO., LTD., Shenzhen, Guangdong (CN)

(72) Inventors: Xiaochen CHEN, Shanghai (CN); Tongbo WANG, Shanghai (CN)

(21) Appl. No.: 15/580,784

(22) PCT Filed: Jun. 9, 2015
(86) PCT No.: PCT/CN2015/081057

§ 371 Date: Dec. 8, 2017

(51) Int. Cl. H04W 64/00

(52) U.S. Cl. CPC H04W 64/00

(57) ABSTRACT

The present disclosure describes a positioning method. In one example method, a target network identifier associated with a mobile terminal is obtained. A determination is made on whether positioning information of a region associated with the obtained target network identifier is stored locally at the mobile terminal. In response to determining that the positioning information of the region is not stored locally at the mobile terminal, the positioning information of the region is downloaded from a server to the mobile terminal and stored at the mobile terminal. In response to receiving a positioning request, geographical location information corresponding to the obtained target network identifier is obtained by the mobile terminal and from the locally stored positioning information of the region stored at the mobile terminal.

### TECHNICAL FIELD

The present invention relates to the field of mobile terminals, and in particular, to a positioning method and apparatus, and a terminal.

### BACKGROUND

Currently, in addition to a GPS positioning technology, network positioning is also a positioning method that is widely applied. In network positioning, a positioning result needs to be obtained from a server of a location service provider by using a network connection.

Current network positioning is mainly implemented as follows: When a user requests to obtain geographical location information of a mobile terminal, the mobile terminal obtains, from a network server according to a network identifier such as a cell identity (Cell ID) and/or a basic service set identifier (Basic Service Set Identification, BSSID) of a Wi-Fi access point (Access Point, AP), a terrestrial geographical location to which the network identifier is mapped. In this way, rough positioning is conveniently implemented.

However, in this positioning manner, every time the user initiates a positioning request, the mobile terminal needs to establish a data connection to the server of the location service provider, and perform data transmission. Therefore, a high requirement is imposed on the network connection. When network signal quality is poor, a positioning speed is reduced obviously.

### SUMMARY

Embodiments of the present invention provide a positioning method and apparatus, and a terminal, to increase a terminal positioning speed.

According to a first aspect, a positioning method is provided and includes:

obtaining a target network identifier;

querying, according to the target network identifier, whether positioning information about a region to which the target network identifier belongs is stored locally, and if the positioning information about the region is not stored, downloading the positioning information about the region from a server to a local end, where the positioning information about the region is geographical location information corresponding to each of multiple network identifiers that the region has, and the multiple network identifiers are used to represent multiple network devices in the region; and

when a positioning request is received, obtaining, from the locally stored positioning information about the region, geographical location information corresponding to the target network identifier.

With reference to the first aspect, in a first possible implementation, the querying, according to the target network identifier, whether positioning information about a region to which the target network identifier belongs is stored locally, includes:

querying whether the geographical location information corresponding to the target network identifier is stored locally, where when the query result is yes, it indicates that the positioning information is stored locally, or when the query result is no, it indicates that the positioning information is not stored locally; or

requesting to obtain, from the server, the region to which the target network identifier belongs, and then querying, according to the region returned by the server, whether the positioning information about the region is stored locally, where when the query result is yes, it indicates that the positioning information about the region is stored locally, or when the query result is no, it indicates that the positioning information about the region is not stored locally.

With reference to the first possible implementation of the first aspect, in a second possible implementation, the querying whether the positioning information about the region is stored locally includes: querying whether the positioning information is stored in a local first storage area; if the positioning information is not stored in the first storage area, querying whether the positioning information is stored in a local second storage area; and if the positioning information is stored in the second storage area, loading the positioning information stored in the second storage area into the first storage area, or if the positioning information is not stored in the second storage area, performing the step of downloading the positioning information about the region from a server to a local end; and

the obtaining, from the locally stored positioning information about the region, geographical location information corresponding to the target network identifier includes: if the positioning information is stored in the first storage area, obtaining, from the first storage area, the geographical location information corresponding to the target network identifier, or if the positioning information is not stored in the first storage area, obtaining, from the second storage area, the geographical location information corresponding to the target network identifier.

With reference to the second possible implementation of the first aspect, the downloading the positioning information about the region from a server to a local end includes: downloading the positioning information from the server to the second storage area; or downloading the positioning information from the server to the first storage area.

With reference to the second possible implementation of the first aspect, or the third possible implementation of the first aspect, in a fourth possible implementation, when loading the positioning information stored in the second storage area into the first storage area, the method further includes: determining whether positioning information about a historical region is stored in the first storage area, and if the positioning information about the historical region is stored, removing the positioning information about the historical region from the first storage area.

With reference to the first aspect, or with reference to any one of the foregoing possible implementations of the first aspect, in a fifth possible implementation, after the querying whether positioning information about a region to which the target network identifier belongs is stored locally, the method further includes:

if the positioning information is stored locally, but the geographical location information corresponding to the target network identifier is not stored, downloading, from the server, the geographical location information corresponding to the target network identifier, and loading the downloaded geographical location information corresponding to the target network identifier into the positioning information.

With reference to the first aspect, in a sixth possible implementation, the method further includes: detecting that a GPS is enabled; receiving geographical location information positioned by the GPS; and updating the geographical location information corresponding to the target network identifier in the locally stored positioning information to the geographical location information positioned by the GPS.

According to a second aspect, a positioning apparatus is provided and includes:

an obtaining unit, configured to obtain a target network identifier;

a querying unit, configured to query, according to the target network identifier, whether positioning information about a region to which the target network identifier belongs is stored locally, where the positioning information about the region is geographical location information corresponding to each of multiple network identifiers that the region has, and the multiple network identifiers are used to represent multiple network devices in the region;

a first downloading unit, configured to download the positioning information about the region from a server to a local end when a query result output by the querying unit is no; and

a positioning unit, configured to obtain, from the locally stored positioning information about the region, geographical location information corresponding to the target network identifier when a positioning request is received.

With reference to the second aspect, in a first possible implementation, the querying unit may be specifically configured to: query whether the geographical location information corresponding to the target network identifier is stored locally, where when the query result is yes, it indicates that the positioning information is stored locally, or when the query result is no, it indicates that the positioning information is not stored locally; or request to obtain, from the server, the region to which the target network identifier belongs, and then query, according to the region returned by the server, whether the positioning information about the region is stored locally, where when the query result is yes, it indicates that the positioning information about the region is stored locally, or when the query result is no, it indicates that the positioning information about the region is not stored locally.

With reference to the first possible implementation of the second aspect, in a second possible implementation, the querying unit includes a first querying subunit, a second querying subunit, a first loading unit, and a download triggering unit, where

the first querying subunit is configured to query whether the positioning information is stored in a local first storage area;

the second querying subunit is configured to query, when a query result of the first querying subunit is no, whether the positioning information is stored in a local second storage area;

the first loading unit is configured to load, when a query result of the second querying subunit is yes, the positioning information stored in the second storage area into the first storage area;

the download triggering unit is configured to trigger the first downloading unit to download the positioning information about the region from the server to the local end when a query result of the second querying subunit is no; and

the positioning unit is specifically configured to: if the positioning information is stored in the first storage area, obtain, from the first storage area, the geographical location information corresponding to the target network identifier, or if the positioning information is not stored in the first storage area, obtain, from the second storage area, the geographical location information corresponding to the target network identifier.

With reference to the second possible implementation of the second aspect, in a third possible implementation, the first downloading unit is specifically configured to: download the positioning information from the server to the second storage area; or download the positioning information from the server to the first storage area.

With reference to the second possible implementation of the second aspect, or with reference to the third possible implementation of the second aspect, in a fourth possible implementation, the apparatus further includes a determining unit and a removing unit, where

the determining unit is configured to determine, when the first loading unit loads the positioning information stored in the second storage area into the first storage area, whether positioning information about a historical region is stored in the first storage area; and

the removing unit is configured to remove the positioning information about the historical region from the first storage area when a result output by the determining unit is yes.

With reference to any one of the second aspect, or the foregoing possible implementations of the second aspect, in a fifth possible implementation, the apparatus further includes a second downloading unit and a second loading unit, where

the second downloading unit is configured to: after the querying unit queries whether the positioning information about the region to which the target network identifier belongs is stored locally, if the positioning information is stored locally, but the geographical location information corresponding to the target network identifier is not stored, download, from the server, the geographical location information corresponding to the target network identifier; and

the second loading unit is configured to load the geographical location information corresponding to the target network identifier and downloaded by the second downloading unit, into the positioning information.

With reference to the second aspect, in a sixth possible implementation, the apparatus further includes a detection unit, a receiving unit, and an updating unit, where

the detection unit is configured to detect that a GPS is enabled;

the receiving unit is configured to receive geographical location information positioned by the GPS; and

the updating unit is configured to update the geographical location information corresponding to the target network identifier in the locally stored positioning information to the geographical location information positioned by the GPS.

According to a third aspect, a terminal is provided and includes an input apparatus, an output apparatus, a memory, and a processor coupled with the memory, where

the processor reads an instruction stored in the memory, so that the processor is configured to perform the following steps:

obtaining a target network identifier;

querying, according to the target network identifier, whether positioning information about a region to which the target network identifier belongs is stored locally, and if the positioning information about the region is not stored, downloading the positioning information about the region from a server to a local end, where

the positioning information about the region is geographical location information corresponding to each of multiple network identifiers that the region has, and the multiple network identifiers are used to represent multiple network devices in the region; and

when a positioning request is received, obtaining, from the locally stored positioning information about the region, geographical location information corresponding to the target network identifier.

With reference to the third aspect, in a first possible implementation, the step, performed by the processor, of querying, according to the target network identifier, whether positioning information about a region to which the target network identifier belongs is stored locally, includes:

querying, by the processor, whether the geographical location information corresponding to the target network identifier is stored locally, where when the query result is yes, it indicates that the positioning information is stored locally, or when the query result is no, it indicates that the positioning information is not stored locally; or

requesting, by the processor, to obtain, from the server, the region to which the target network identifier belongs, and then querying, according to the region returned by the server, whether the positioning information about the region is stored locally, where when the query result is yes, it indicates that the positioning information about the region is stored locally, or when the query result is no, it indicates that the positioning information about the region is not stored locally.

With reference to the first possible implementation of the third aspect, in a second possible implementation, the step, performed by the processor, of querying whether the positioning information about the region is stored locally, includes: querying, by the processor, whether the positioning information is stored in a local first storage area; if the positioning information is not stored in the first storage area, querying whether the positioning information is stored in a local second storage area; and if the positioning information is stored in the second storage area, loading the positioning information stored in the second storage area into the first storage area, or if the positioning information is not stored in the second storage area, performing the step of downloading the positioning information about the region from a server to a local end; and

the step, performed by the processor, of obtaining, from the locally stored positioning information about the region, geographical location information corresponding to the target network identifier includes: if the positioning information is stored in the first storage area, obtaining, by the processor from the first storage area, the geographical location information corresponding to the target network identifier, or if the positioning information is not stored in the first storage area, obtaining, by the processor from the second storage area, the geographical location information corresponding to the target network identifier.

With reference to the second possible implementation of the third aspect, in a third possible implementation, the step, performed by the processor, of downloading the positioning information about the region from a server to a local end includes: downloading, by the processor, the positioning information from the server to the second storage area; or downloading, by the processor, the positioning information from the server to the first storage area.

With reference to the second possible implementation of the third aspect, or with reference to the third possible implementation of the third aspect, in a fourth possible implementation, the processor is further configured to: when loading the positioning information stored in the second storage area into the first storage area, determine whether positioning information about a historical region is stored in the first storage area, and if the positioning information about the historical region is stored, remove the positioning information about the historical region from the first storage area.

With reference to any one of the third aspect, or the foregoing possible implementations of the third aspect, in a fifth possible implementation, the processor is further configured to: after querying whether the positioning information about the region to which the target network identifier belongs is stored locally, if the positioning information is stored locally, but the geographical location information corresponding to the target network identifier is not stored, download, from the server, the geographical location information corresponding to the target network identifier, and load the downloaded geographical location information corresponding to the target network identifier into the positioning information.

With reference to the third aspect, in a sixth possible implementation, the processor is further configured to: detect that a GPS is enabled; receive geographical location information positioned by the GPS; and update the geographical location information corresponding to the target network identifier in the locally stored positioning information to the geographical location information positioned by the GPS.

In implementations of the embodiments of the present invention, a terminal queries, according to a target network identifier, whether positioning information about a region to which the target network identifier belongs is stored locally, and if the positioning information about the region is not stored, downloads the positioning information about the region from a server to a local end; and when a positioning request is received, the terminal obtains, from the locally stored positioning information about the region, geographical location information corresponding to the target network identifier. The geographical location information of the terminal can be directly obtained from the local end according to the target network identifier. Therefore, dependency of terminal positioning on a network is reduced, interactions between the terminal and the server are reduced, and a positioning speed is increased effectively.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a schematic diagram of a network positioning system used in an embodiment of the present invention;

FIG. 2 is a flowchart of a first embodiment of a positioning method according to an embodiment of the present invention;

FIG. 3 is a flowchart of a first embodiment of a positioning method according to an embodiment of the present invention;

FIG. 4 is a schematic structural diagram of a first embodiment of a positioning apparatus according to an embodiment of the present invention;

FIG. 5 is a schematic structural diagram of a second embodiment of a positioning apparatus according to an embodiment of the present invention;

FIG. 6 is a schematic structural diagram of a third embodiment of a positioning apparatus according to an embodiment of the present invention; and

FIG. 7 is a schematic structural diagram of a terminal according to an embodiment of the present invention.

### DESCRIPTION OF EMBODIMENTS

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

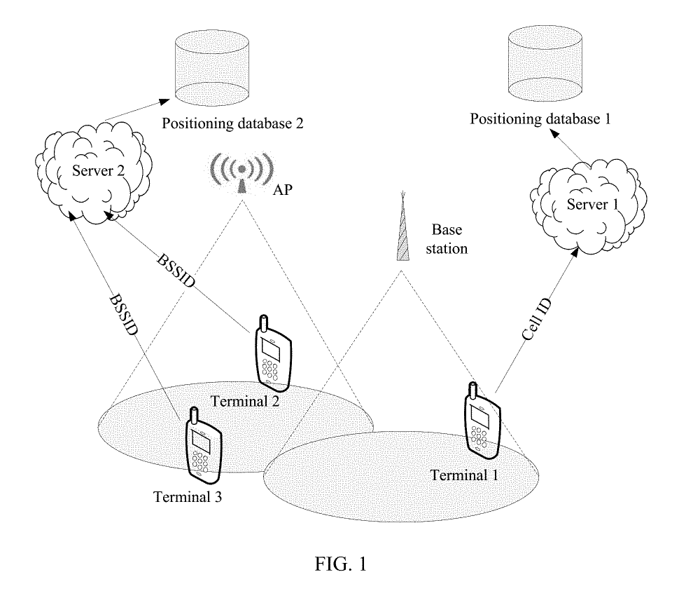

FIG. 1 is a schematic diagram of a network positioning system used in an embodiment of the present invention. Two positioning manners are reflected: cell ID (cell identity) positioning and Wi-Fi positioning.

A positioning principle of the cell ID positioning is: a network positions a terminal according to a cell in which the terminal is located and a location of a base station of the cell. Specifically, as shown in FIG. 1, the base station sends, to a terminal 1 in a cell controlled by the base station, a cell ID of the cell; the terminal 1 initiates a positioning request to a server 1 by using a network connection, where the positioning request includes the cell ID of the cell; the server 1 finds geographical coordinates of the cell from a positioning database 1 according to the cell ID in the positioning request, and further estimates a geographical location of the terminal 1 roughly. The estimated geographical location of the terminal 1 may be a geographical location of the base station in the cell, or may be another geographical location in the cell.

Similar to the cell ID positioning, a positioning principle of the Wi-Fi positioning is: the network positions a terminal according to an access point to which the terminal is connected and a location of the access point. Specifically, as shown in FIG. 1, a Wi-Fi access point (AP) sends a BSSID (a MAC address of the AP) to a terminal 2 connected to the Wi-Fi access point; the terminal 2 initiates a positioning request to a server 2 by using a network connection, where the positioning request includes the BSSID of the AP; the server 2 finds geographical coordinates of the AP from a positioning database 2 according to the BSSID in the positioning request, and further estimates a geographical location of the terminal roughly. The estimated geographical location of the terminal 2 may be a geographical location of the AP to which the terminal 2 is connected, or may be another geographical location within coverage of the AP.

The positioning database 1 may include geographical location information of a base station provided by a location service provider. The positioning database 2 may include geographical location information of an access point device provided by the location service provider. Geographical location information of a network device may include longitudinal and latitudinal coordinates, positioning precision information, and the like of the network device.

In an existing network positioning system, every time a terminal initiates a positioning request, the terminal needs to establish a network connection to a location server to obtain a positioning result from the location server. This positioning manner imposes a high requirement on the network connection. When network signal quality is poor, a positioning speed is reduced obviously.

In a technical solution provided by an embodiment of the present invention, a terminal downloads, in a background when a network connection exists, positioning information about a region to which a target network identifier belongs, to the terminal. When a user initiates a positioning request, the terminal can directly obtain, from the locally stored positioning information about the region, geographical location information corresponding to the target network identifier. Therefore, dependency of terminal positioning on a network is reduced, interactions between the terminal and a server are reduced, and a positioning speed may be increased effectively.

The region to which the target network identifier belongs is a region to which a network device (such as a base station or an access point) represented by the target network identifier belongs. For example, a region to which a cell ID of a base station A (installed in a city B) belongs is a region to which the base station A belongs, namely, the city B. The positioning information about the region is geographical location information corresponding to each of multiple network identifiers that the region has, and the multiple network identifiers are used to represent multiple network devices in the region. That is, the positioning information about the region includes geographical location information of the multiple network devices in the region. For example, if the city B is a region to which the base station A, a base station B, and a base station C belong, positioning information about the city B may include: geographical location information of the three base stations A, B, and C.

Embodiments of the present invention disclose a positioning method and apparatus, and a terminal, to increase a positioning speed effectively. The embodiments are hereinafter described in detail separately.

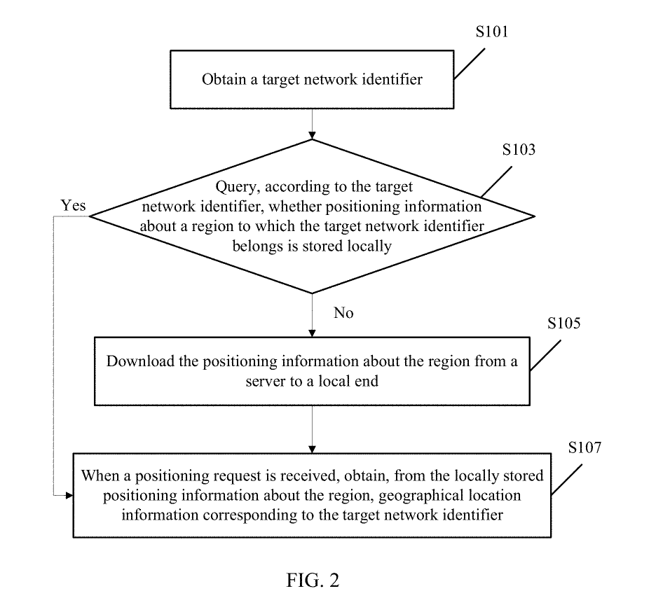

FIG. 2 is a flowchart of a first embodiment of a positioning method according to an embodiment of the present invention. Referring to FIG. 2, the method includes the following steps.

S101. Obtain a target network identifier.

Specifically, the target network identifier may be a cell identity obtained by a terminal from a base station at a current time, or a network identifier such as a basic service set identifier of a wireless network access point that is obtained by a terminal at a current time.

It should be noted that, the target network identifier may also be a combination of the foregoing two network identifiers, and higher-precision positioning may be implemented. In a specific implementation, the terminal may compare geographical location information corresponding to the foregoing two network identifiers, and determine geographical location information corresponding to a network identifier with higher positioning precision as geographical location information of the terminal. The terminal may also determine an intersection part indicated by the geographical location information corresponding to the foregoing two network identifiers as geographical location information of the terminal.

S103. Query, according to the target network identifier, whether positioning information about a region to which the target network identifier belongs is stored locally.

The region to which the target network identifier belongs, used in this embodiment of the present invention, is a region to which a network device (such as a base station or an access point) represented by the target network identifier belongs.

It may be understood that, in a small range, the terminal is currently located within coverage of signals of the network device represented by the target network identifier, for example, a cell A; and in a large range, the terminal is currently also located in the region to which the target network identifier belongs, for example, a city B.

The positioning information about the region, used in this embodiment of the present invention, includes geographical location information corresponding to each of multiple network identifiers that the region has, and the multiple network identifiers are used to represent multiple network devices in the region. That is, the positioning information about the region includes geographical location information of the multiple network devices in the region.

It should be noted that, the region used in this embodiment may be a geographical region such as a city or a county, or may be a geographical region limited by longitudinal and latitudinal numeric values. The region used in this embodiment may also be a region in a communication sense. For example, the region is a cell cluster formed by multiple neighboring cells.

Specifically, when a query result obtained by performing S103 is yes, step S107 may be performed. That is, when the terminal locally stores the positioning information about the region in which the terminal is currently located, the terminal may wait for receiving a positioning request. When a query result obtained by performing S103 is no, step S105 may be performed. That is, when the terminal locally does not store the positioning information about the region in which the terminal is currently located, the terminal may download the positioning information to a local end.

S105. Download the positioning information about the region from a server to a local end.

S107. When a positioning request is received, obtain, from the locally stored positioning information about the region, geographical location information corresponding to the target network identifier.

It may be understood that, the terminal is currently located within the coverage of the signals of the network device represented by the target network identifier. Therefore, the geographical location information corresponding to the target network identifier may roughly indicate a current geographical location of the terminal.

It should be noted that, in this embodiment of the present invention, S107 is not limited to being performed after S105, but may be triggered at any time by the positioning request initiated by the user.

Optionally, the terminal may perform S101 to S105 after power-on, or may perform S101 to S105 after the terminal accesses a network, or may perform S101 to S105 at regular intervals.

Preferably, the terminal may always perform S101 to S105 in a background, or the terminal may perform S101 to S105 immediately when the location of the terminal changes. In this way, the terminal may always locally store the positioning information about the region to which the target network identifier belongs.

Specifically, the positioning information locally stored by the terminal may be shown in Table 1:

TABLE 1

| | Geographical location information | | |
|---|---|---|---|
| Cell identity | Longitude | Latitude | Precision |
| Cell ID 1 | 100°15′30″E | 28°35′10″N | 100 meters |
| Cell ID 2 | 100°15′11″E | 28°35′20″N | 150 meters |
| Cell ID 3 | 100°15′8″E | 28°35′30″N | 200 meters |

In this embodiment of the present invention, the terminal may query, in at least the following two implementations, whether the terminal locally stores the positioning information about the region to which the target network identifier belongs. Manner 1: The terminal may query whether the geographical location information corresponding to the target network identifier is stored locally, where when the query result is yes, it indicates that the positioning information is stored locally, or when the query result is no, it indicates that the positioning information is not stored locally.

For example, the terminal locally stores positioning information about a city A as shown in Table 1. If the target network identifier obtained by the terminal is the cell ID 1, geographical location information corresponding to the cell ID 1 may be found on the terminal locally, and it may be determined that the positioning information about the city A (a region to which the cell ID 1 belongs) is stored on the terminal locally.

Manner 2: The terminal may request to obtain, from the server, the region to which the target network identifier belongs, and then query, according to the region returned by the server, whether the positioning information about the region is stored locally, where when the query result is yes, it indicates that the positioning information about the region is stored locally, or when the query result is no, it indicates that the positioning information about the region is not stored locally.

For example, if the target network identifier obtained by the terminal is the cell ID 1, a region to which the cell ID 1 returned by the server belongs is the city A. In this case, the terminal may directly find the positioning information about the city A on the terminal locally, that is, it may be determined that the positioning information about the region to which the cell ID 1 belongs is stored on the terminal locally.

Particularly, when the terminal is connected to a network device added in the city A (geographical location information about the added network device is not stored on the terminal locally), the terminal may learn, from the server in the foregoing manner 2, that a region to which the added device belongs is the city A, and the terminal may query whether the positioning information about the city A is stored on the terminal locally.

In this embodiment of the present invention, if the terminal locally stores the positioning information (such as the positioning information about the city A), but does not store the geographical location information corresponding to the target network identifier (such as the geographical location information about the added network device), the terminal may download, from the server, the geographical location information corresponding to the target network identifier (the geographical location information about the added network device), and load the geographical location information corresponding to the target network identifier (the geographical location information about the added network device) into the positioning information (the positioning information about the city A). In this way, the geographical location information about the added network device in the region in which the terminal is currently located can be loaded into the positioning information locally stored by the terminal, and the positioning information locally stored by the terminal can be further improved.

It should be noted that, the positioning information shown in Table 1 is only an implementation of this embodiment of the present invention. In actual use, the positioning information locally stored by the terminal may further include other positioning information, for example, a BSSID of a Wi-Fi access point and geographical location information corresponding to the BSSID.

It should be noted that, the target network identifier used in this embodiment of the present invention may also be a historical network identifier (rather than the network identifier obtained at the current time) obtained by the terminal, and a historical location of the terminal may be traced back according to geographical location information corresponding to the historical network identifier.

It should be noted that, the target network identifier used in this embodiment of the present invention may also be an external network identifier (a network identifier transmitted by an external device and received by the terminal) obtained by the terminal. For example, the terminal receives an external network identifier sent by a wearable device. The terminal may obtain geographical location information about the wearable device according to the external network identifier, and may trace a carrier of the wearable device.

Optionally, in this embodiment of the present invention, when the terminal detects that a GPS on the terminal is enabled, the terminal may further receive geographical location information positioned by the GPS, and update the geographical location information corresponding to the target network identifier in the locally stored positioning information to the geographical location information positioned by the GPS. Due to a feature of precise GPS positioning, this may further improve precision of the positioning information locally stored.

For example, geographical location information positioned by the GPS at the current time is (100°15′8″E, 28°35′30″N), and the target network identifier at the current time is the cell ID 1 in Table 1. In this case, the terminal may update the longitude and latitude of the cell ID 1 in the positioning information shown in Table 1 to (100°15′8″E, 28°35′30″N).

In an implementation of this embodiment of the present invention, a terminal queries, according to the target network identifier, whether positioning information about a region to which the target network identifier belongs is stored locally, and if the positioning information about the region is not stored, downloads the positioning information about the region from a server to a local end; and when a positioning request is received, the terminal obtains, from the locally stored positioning information about the region, geographical location information corresponding to the target network identifier. The geographical location information of the terminal can be directly obtained from the local end according to the target network identifier. Therefore, dependency of terminal positioning on a network is reduced, interactions between the terminal and the server are reduced, and a positioning speed is increased effectively.

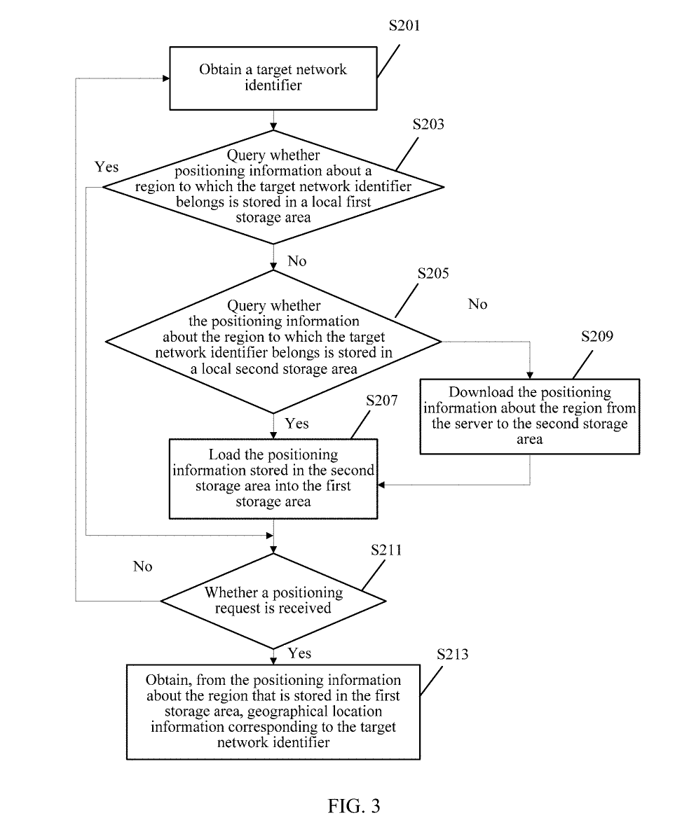

FIG. 3 is a flowchart of a first embodiment of a positioning method according to an embodiment of the present invention. According to the embodiment corresponding to FIG. 3, positioning information locally stored by a terminal is stored in a first storage area and a second storage area respectively. Positioning information about a region in which the terminal is currently located (a region to which the target network identifier belongs) is stored in the first storage area, and positioning information about a historical region is stored in the second storage area. In this way, the terminal may directly find information about a current geographical location of the terminal from the first storage area (geographical location information corresponding to the target network identifier), a query time may be reduced, and a positioning speed is further increased. The method shown in FIG. 3 is an improvement on the method shown in FIG. 2. For content that is not mentioned in the embodiment corresponding to FIG. 3, refer to descriptions about the embodiment corresponding to FIG. 2. Referring to FIG. 3, the method includes the following steps.

S201. Obtain a target network identifier.

Specifically, the target network identifier may be a cell identity obtained by a terminal from a base station at a current time, or a network identifier such as a basic service set identifier of a wireless network access point that is obtained by a terminal at a current time.

S203. Query whether positioning information about a region to which the target network identifier belongs is stored in a local first storage area.

Specifically, when a query result obtained by performing S203 is no, the terminal may perform step S205. That is, if the positioning information about the region in which the terminal is currently located (the region to which the target network identifier belongs) is not stored in the first storage area, the terminal may query whether the positioning information about the region in which the terminal is currently located is stored in a local second storage area. When a query result obtained by performing S203 is yes, the terminal may perform step S211. That is, if the positioning information about the region in which the terminal is currently located is not stored in the first storage area, the terminal may wait for receiving a positioning request.

S205. Query whether the positioning information about the region to which the target network identifier belongs is stored in a local second storage area.

The second storage area in this embodiment of the present invention may be used to back up positioning information about a historical region in which the terminal is located. For example, cities visited by the terminal include cities A, B, and C. In this case, positioning information about the three cities A, B, and C is stored in the second storage area.

Specifically, when a query result obtained by performing S205 is no, step S209 may be performed. That is, if the positioning information about the region in which the terminal is currently located (the region to which the target network identifier belongs) is not stored in the local second storage area, the terminal may download the positioning information from a server. When a query result obtained by performing S205 is yes, step S207 may be performed. That is, if the positioning information is stored in the local second storage area, the terminal may load the positioning information into the first storage area.

S207. Load the positioning information stored in the second storage area into the first storage area.

That is, if the positioning information about the region in which the terminal is currently located (the region to which the target network identifier belongs) is not stored in the local first storage area, but the positioning information about the region in which the terminal is currently located is stored in the local second storage area, the terminal may perform S207.

S209. Download the positioning information about the region from the server to the second storage area.

Specifically, if the positioning information about the region is not stored locally (the first storage area and the second storage area), the terminal may download the positioning information about the region to the second storage area, and trigger execution of step S207, so that the positioning information about the region is stored in the first storage area.

S211. Whether a positioning request is received.

In a specific implementation, the terminal may wait, in a polling (Polling) manner, for receiving the positioning request, or may receive the positioning request by monitoring a preset positioning request event.

Specifically, when the terminal receives the positioning request by performing S211, the terminal may perform S213; or when the terminal does not receive the positioning request by performing S211, the terminal may perform S201. In an actual application, the terminal may perform S211 repeatedly, and this is not limited herein.

S213. Obtain, from the positioning information about the region that is stored in the first storage area, geographical location information corresponding to the target network identifier.

It may be understood that, the terminal is currently located within coverage of signals of a network device represented by the target network identifier. Therefore, the geographical location information corresponding to the target network identifier may roughly indicate a current geographical location of the terminal.

Optionally, the terminal may perform S201 to S209 after power-on, or may perform S201 to S209 after the terminal accesses a network, or may perform S201 to S209 at regular intervals.

Preferably, the terminal may always perform S201 to S209 in a background, or the terminal may perform S201 to S209 immediately when the location of the terminal changes. In this way, the terminal may always locally store the positioning information about the region to which the target network identifier belongs.

In this embodiment of the present invention, when performing S207, the terminal may further determine whether positioning information about a historical region in which the terminal is located is stored in the first storage area, and if the positioning information about the historical region is stored, remove the positioning information about the historical region from the first storage area. In this way, it may be ensured that only the positioning information about the region to which the target network identifier belongs is stored in the first storage area. This may reduce a query time and further increase a positioning speed.

It should be noted that, if the positioning information about the region is not stored on the terminal locally (the first storage area and the second storage area), when performing S209, the terminal may also not back up the positioning information about the region that is downloaded from the server, to the second storage area, but directly store the positioning information about the region in the first storage area.

Optionally, in this embodiment of the present invention, the first storage area and the second storage area may be locally stored files and may be stored in a portable manner, so that the positioning information stored in the first storage area and the second storage area may be shared and backed up between terminals. For example, a local first storage area and a local second storage area of the terminal 1 may be copied to a terminal 2, so that the terminal 2 may directly have the local positioning information of the terminal 1 without obtaining or downloading the information from the server.

In an implementation of this embodiment of the present invention, positioning information locally stored by a terminal is stored in a first storage area and a second storage area respectively. Positioning information about a region to which the target network identifier belongs is stored in the first storage area, and the terminal queries, from the first storage area, geographical location information corresponding to the target network. This may reduce a local query time for the terminal and increase a positioning speed effectively.

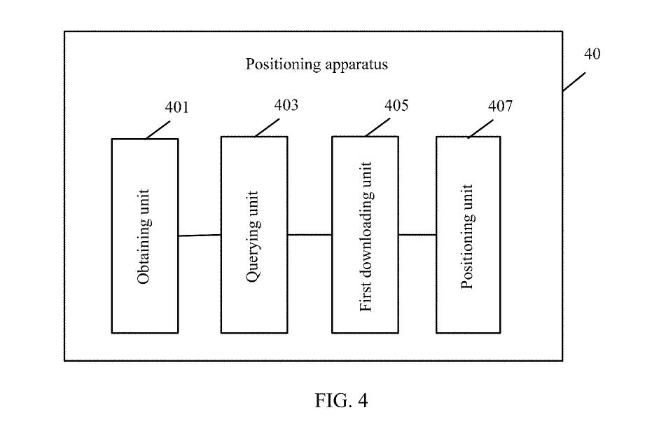

FIG. 4 is a schematic structural diagram of a first embodiment of a positioning apparatus according to an embodiment of the present invention. The positioning apparatus 40 shown in FIG. 4 may include an obtaining unit 401, a querying unit 403, a first downloading unit 405, and a positioning unit 407. The positioning apparatus 40 may be used to perform the methods in the embodiments in FIG. 2 and FIG. 3. For content that is not mentioned in the embodiment shown in FIG. 4, refer to descriptions about the embodiments corresponding to FIG. 2 and FIG. 3 respectively.

The obtaining unit 401 is configured to obtain a target network identifier.

The querying unit 403 is configured to query, according to the target network identifier, whether positioning information about a region to which the target network identifier belongs is stored locally, where the positioning information about the region is geographical location information corresponding to each of multiple network identifiers that the region has, and the multiple network identifiers are used to represent multiple network devices in the region.

The first downloading unit 405 is configured to download the positioning information about the region from a server to a local end when a query result output by the querying unit 403 is no, where the positioning information includes the network identifiers and geographical location information corresponding to the network identifiers.

The positioning unit 407 is configured to obtain, from the locally stored positioning information about the region, geographical location information corresponding to the target network identifier when a positioning request is received.

In this embodiment of the present invention, the querying unit 403 may query, in at least the following two implementations, whether the terminal locally stores the positioning information about the region to which the target network identifier belongs.

Manner 1: The querying unit 403 may query whether the geographical location information corresponding to the target network identifier is stored locally, where when the query result is yes, it indicates that the positioning information is stored locally, or when the query result is no, it indicates that the positioning information is not stored locally.

Manner 2: The querying unit 403 may request to obtain, from the server, the region to which the target network identifier belongs, and then query, according to the region returned by the server, whether the positioning information about the region is stored locally, where when the query result is yes, it indicates that the positioning information about the region is stored locally, or when the query result is no, it indicates that the positioning information about the region is not stored locally.

In an implementation of the present invention, the positioning information locally stored by the terminal may be stored in a first storage area and a second storage area respectively. The positioning information about the region in which the terminal is currently located (the region to which the target network identifier belongs) is stored in the first storage area, and positioning information about a historical region is stored in the second storage area. In this way, the terminal may directly find information about a current geographical location of the terminal from the first storage area (the geographical location information corresponding to the target network identifier), and a query time may be reduced.

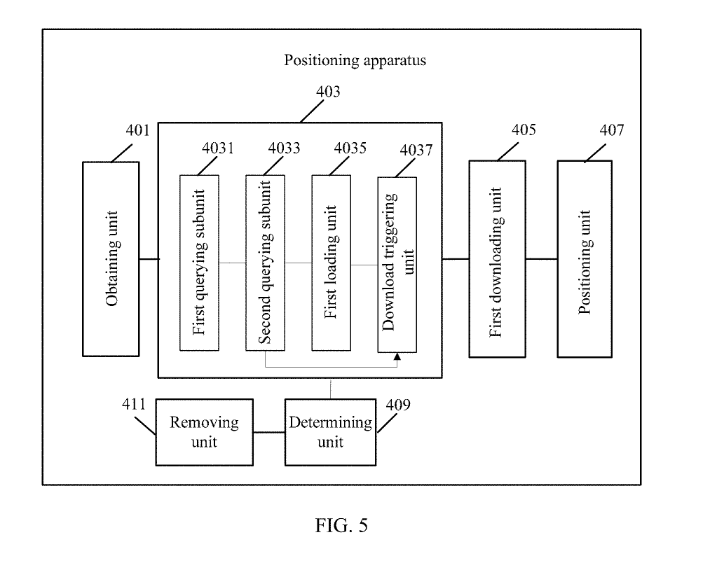

Further, when the querying unit 403 queries, in the manner 2, whether the positioning information is locally stored by the terminal, the querying unit 403 may include a first querying subunit 4031, a second querying subunit 4033, a first loading unit 4035, and a download triggering unit 4037, as shown in FIG. 5.

The first querying subunit 4031 is configured to query whether the positioning information is stored in a local first storage area.

The second querying subunit 4033 is configured to query, when a query result of the first querying subunit 4031 is no, whether the positioning information is stored in a local second storage area.

The first loading unit 4035 is configured to load, when a query result of the second querying subunit 4033 is yes, the positioning information stored in the second storage area into the first storage area.

The download triggering unit 4037 is configured to trigger the first downloading unit to download the positioning information about the region from the server to the local end when a query result of the second querying subunit 4033 is no.

In a specific implementation, if the positioning information is stored in the first storage area, the positioning unit 407 may obtain, from the first storage area, the geographical location information corresponding to the target network identifier. If the positioning information is not stored in the first storage area, the positioning unit 407 may obtain, from the second storage area, the geographical location information corresponding to the target network identifier.

In a specific implementation, the first downloading unit 405 may be specifically configured to: download the positioning information from the server to the second storage area; or download the positioning information from the server to the first storage area.

Still further, as shown in FIG. 5, the positioning apparatus 40 may further include a first determining unit 409 and a removing unit 411 in addition to the obtaining unit 401, the querying unit 403, the first downloading unit 405, and the positioning unit 407.

The determining unit 409 is configured to determine, when the first loading unit 4035 loads the positioning information stored in the second storage area into the first storage area, whether positioning information about a historical region is stored in the first storage area.

The removing unit 411 is configured to remove the positioning information about the historical region from the first storage area when a result output by the determining unit 409 is yes.

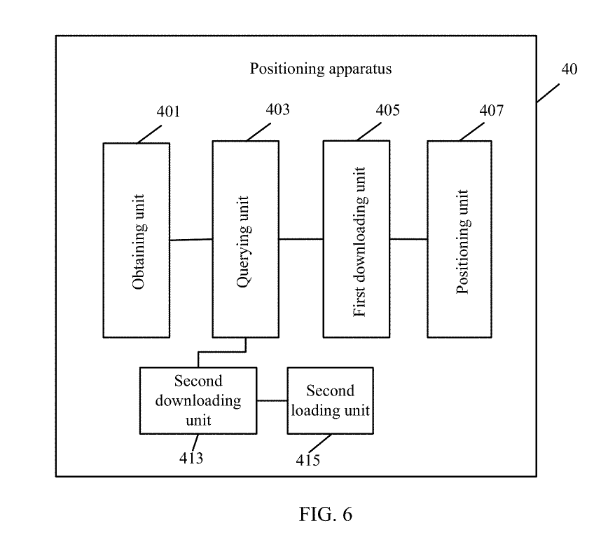

Still further, as shown in FIG. 6, the positioning apparatus 40 may further include a second downloading unit 413 and a second loading unit 415 in addition to the obtaining unit 401, the querying unit 403, the first downloading unit 405, and the positioning unit 407.

The second downloading unit 413 is configured to: after the querying unit 403 queries whether the positioning information about the region to which the target network identifier belongs is stored locally, if the positioning information is stored locally, but the geographical location information corresponding to the target network identifier is not stored, download, from the server, the geographical location information corresponding to the target network identifier.

The second loading unit 415 is configured to load the geographical location information corresponding to the target network identifier and downloaded by the second downloading unit, into the positioning information.

Still further, in this embodiment of the present invention, the positioning apparatus 40 may further include a detection unit, a receiving unit, and an updating unit in addition to the obtaining unit 401, the querying unit 403, the first downloading unit 405, and the positioning unit 407.

The detection unit is configured to detect that a GPS is enabled.

The receiving unit is configured to receive geographical location information positioned by the GPS.

The updating unit is configured to update the geographical location information corresponding to the target network identifier in the locally stored positioning information to the geographical location information positioned by the GPS.

It may be understood that, functions of the functional modules in the positioning apparatus 40 may be specifically implemented according to the method in the foregoing method embodiment. Details are not further described herein.

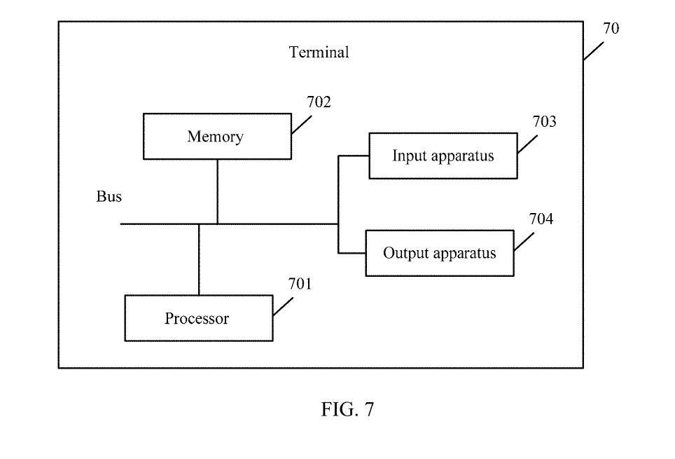

To better implement the foregoing solutions in the embodiments of the present invention, the present invention further provides a terminal used in cooperation for implementing the foregoing solutions. With reference to a schematic structural diagram of a terminal 70 provided by the present invention as shown in FIG. 7, the following describes the terminal in detail.

The terminal 70 includes an input apparatus 703, an output apparatus 704, a memory 702, and a processor 701 coupled with the memory 702 (a quantity of processors 701 in the terminal 70 may be one or more, and one processor is used as an example in FIG. 7). In some embodiments of the present invention, the input apparatus 703, the output apparatus 704, the memory 702, and the processor 701 may be connected by a bus or in other manners, and the connection by a bus is used as an example in FIG. 7.

The memory 702 is configured to store program code. The processor 701 is configured to invoke the program code stored in the memory 702, so that the processor is configured to perform the following steps:

obtaining a target network identifier;

querying, according to the target network identifier, whether positioning information about a region to which the target network identifier belongs is stored locally, and if the positioning information about the region is not stored, downloading the positioning information about the region from a server to a local end, where

the positioning information about the region is geographical location information corresponding to each of multiple network identifiers that the region has, and the multiple network identifiers are used to represent multiple network devices in the region; and

when a positioning request is received, obtaining, from the locally stored positioning information about the region, geographical location information corresponding to the target network identifier.

In this embodiment of the present invention, the processor 701 may query, in at least the following two implementations, whether the terminal locally stores the positioning information about the region to which the target network identifier belongs.

Manner 1: The processor 701 may query whether the geographical location information corresponding to the target network identifier is stored locally, where when the query result is yes, it indicates that the positioning information is stored locally, or when the query result is no, it indicates that the positioning information is not stored locally.

Manner 2: The processor 701 may request to obtain, from the server, the region to which the target network identifier belongs, and then query, according to the region returned by the server, whether the positioning information about the region is stored locally, where when the query result is yes, it indicates that the positioning information about the region is stored locally, or when the query result is no, it indicates that the positioning information about the region is not stored locally.

In this embodiment of the present invention, the positioning information locally stored by the terminal may be stored in a first storage area and a second storage area respectively. The positioning information about the region in which the terminal is currently located (the region to which the target network identifier belongs) is stored in the first storage area, and positioning information about a historical region is stored in the second storage area. In this way, the processor 701 may directly find information about a current geographical location of the terminal from the first storage area (the geographical location information corresponding to the target network identifier), and a query time may be reduced.

Further, when the processor 701 queries, in the foregoing manner 2, whether the positioning information is locally stored by the terminal, the processor 701 may first query whether the positioning information is stored in a local first storage area, and if the positioning information is not stored in the first storage area, then query whether the positioning information is stored in a local second storage area. If the positioning information is stored in the second storage area, the processor 701 may load the positioning information stored in the second storage area into the first storage area. If the positioning information is not stored in the second storage area, the processor 701 may download the positioning information about the region from the server to the local end.

In a specific implementation, the processor 701 may download the positioning information from the server to the second storage area; or download the positioning information from the server to the first storage area.

When the processor 701 obtains, from the locally stored positioning information about the region, the geographical location information corresponding to the target network identifier, if the positioning information is stored in the first storage area, the processor 701 may obtain, from the first storage area, the geographical location information corresponding to the target network identifier, or if the positioning information is not stored in the first storage area, the processor 701 may obtain, from the second storage area, the geographical location information corresponding to the target network identifier.

When the processor 701 loads the positioning information stored in the second storage area into the first storage area, the processor 701 may determine whether positioning information about a historical region is stored in the first storage area; and if the positioning information about the historical region is stored in the first storage area, the processor 701 may remove the positioning information about the historical region from the first storage area. In this way, it may be ensured that only the positioning information about the region to which the target network identifier belongs is stored in the first storage area. This may further increase a positioning speed.

Still further, if the positioning information is locally stored by the terminal, but the geographical location information corresponding to the target network identifier is not stored, the processor 701 may download, from the server, the geographical location information corresponding to the target network identifier, and load the downloaded geographical location information corresponding to the target network identifier into the positioning information. In this way, geographical location information about an added network device (the geographical location information corresponding to the target network identifier) in the region in which the terminal is currently located can be loaded into the positioning information locally stored by the terminal, and the positioning information locally stored by the terminal can be further improved.

In addition, the processor 701 may further detect that a GPS is enabled. The processor 701 may further receive, by using the input apparatus 703, geographical location information positioned by the GPS. The processor 701 may further update the geographical location information corresponding to the target network identifier in the locally stored positioning information to the geographical location information positioned by the GPS.

In summary, in implementations of the embodiments of the present invention, a terminal queries, according to a target network identifier, whether positioning information about a region to which the target network identifier belongs is stored locally, and if the positioning information about the region is not stored, downloads the positioning information about the region from a server to a local end; and when a positioning request is received, the terminal obtains, from the locally stored positioning information about the region, geographical location information corresponding to the target network identifier. The geographical location information of the terminal can be directly obtained from the local end according to the target network identifier. Therefore, dependency of terminal positioning on a network is reduced, interactions between the terminal and the server are reduced, and a positioning speed is increased effectively.

What is claimed is:

1-21. (canceled)

22. A positioning method, comprising:
obtaining, by a mobile terminal, a target network identifier associated with the mobile terminal;
determining, by the mobile terminal and according to the obtained target network identifier, whether positioning information of a region associated with the obtained target network identifier is stored locally at the mobile terminal;
in response to determining that the positioning information of the region is not stored locally at the mobile terminal:
downloading, by the mobile terminal, the positioning information of the region from a server to the mobile terminal, wherein the positioning information of the region comprises geographical location information corresponding to multiple network identifiers associated with the region, and wherein the multiple network identifiers are associated with multiple network devices located in the region; and
storing, by the mobile terminal, the downloaded positioning information of the region at the mobile terminal; and
in response to receiving a positioning request, obtaining, by the mobile terminal and from the locally stored positioning information of the region stored at the mobile terminal, geographical location information corresponding to the obtained target network identifier.

23. The method according to claim 22, wherein determining, by the mobile terminal and according to the obtained target network identifier, whether positioning information of a region associated with the obtained target network identifier is stored locally at the mobile terminal, comprises:
obtaining, by the mobile terminal and from the server, the region associated with the obtained target network identifier; and
determining, by the mobile terminal and according to the obtained region, whether the positioning information of the region is stored locally at the mobile terminal.

24. The method according to claim 23, wherein determining, by the mobile terminal and according to the obtained region, whether the positioning information of the region is stored locally at the mobile terminal, comprises:
determining whether the positioning information of the region is stored locally at the mobile terminal in a first storage area;
in response to determining that the positioning information of the region is not stored locally at the mobile terminal in the first storage area:
determining whether the positioning information of the region is stored locally at the mobile terminal in a second storage area;
in response to determining that the positioning information of the region is stored locally at the mobile terminal in the second storage area, loading the positioning information of the region stored in the second storage area into the first storage area; and
in response to determining that the positioning information of the region is not stored locally at the mobile terminal in the second storage area, downloading the positioning information of the region from the server to the mobile terminal; and
wherein obtaining, by the mobile terminal and from the locally stored positioning information of the region stored at the mobile terminal, geographical location information corresponding to the obtained target network identifier comprises:
if the positioning information of the region is stored locally at the mobile terminal in the first storage area, obtaining, from the first storage area, the geographical location information corresponding to the obtained target network identifier; and
if the positioning information of the region is not stored locally at the mobile terminal in the first storage area, obtaining, from the second storage area, the geographical location information corresponding to the obtained target network identifier.

25. The method according to claim 24, wherein downloading the positioning information of the region from the server to the mobile terminal comprises: downloading the positioning information of the region from the server to at least one of the second storage area and the first storage area.

26. The method according to claim 24, wherein loading the positioning information of the region stored in the second storage area into the first storage area comprises:
determining whether positioning information of a historical region is stored in the first storage area; and
if the positioning information of the historical region is stored, removing the positioning information of the historical region from the first storage area.

27. The method according to claim 22, wherein after determining whether positioning information of a region associated with the obtained target network identifier is stored locally at the mobile terminal, the method further comprises:
if the positioning information is stored locally at the mobile terminal and the geographical location information corresponding to the obtained target network identifier is not stored locally at the mobile terminal:
downloading, from the server to the mobile terminal, the geographical location information corresponding to the obtained target network identifier; and
loading the downloaded geographical location information corresponding to the obtained target network identifier into the positioning information.

28. The method according to claim 22, further comprising:
detecting that a GPS is enabled;
receiving geographical location information from the GPS; and
updating the geographical location information corresponding to the obtained target network identifier in the locally stored positioning information with the geographical location information from the GPS.

29. A terminal, comprising:
one or more hardware processors; and
a non-transitory computer-readable storage medium coupled to the one or more hardware processors and storing programming instructions for execution by the one or more hardware processors, wherein the programming instructions instruct the one or more hardware processors to:
obtain a target network identifier associated with the terminal;
determine, according to the obtained target network identifier, whether positioning information of a region associated with the obtained target network identifier is stored locally at the terminal;
in response to determining that the positioning information of the region is not stored locally at the terminal:
download the positioning information of the region from a server to the terminal, wherein
the positioning information of the region comprises geographical location information corresponding to multiple network identifiers associated with the region, and wherein the multiple network identifiers are associated with multiple network devices located in the region; and
store the downloaded positioning information of the region at the terminal; and
in response to receiving a positioning request, obtain, from the locally stored positioning information of the region stored at the terminal, geographical location information corresponding to the obtained target network identifier.

30. The terminal according to claim 29, wherein determining, according to the obtained target network identifier, whether positioning information of a region associated with the obtained target network identifier is stored locally at the terminal, comprises:
obtaining, from the server, the region associated with the obtained target network identifier; and
determining, according to the obtained region, whether the positioning information of the region is stored locally at the terminal.

31. The terminal according to claim 30, wherein determining whether the positioning information of the region is stored locally at the terminal, comprises:
determining whether the positioning information of the region is stored locally at the terminal in a first storage area;
in response to determining that the positioning information of the region is not stored locally at the terminal in the first storage area:
determining whether the positioning information of the region is stored locally at the terminal in a second storage area; and
in response to determining that the positioning information of the region is stored locally at the terminal in the second storage area, loading the positioning information of the region stored in the second storage area into the first storage area; and
in response to determining that the positioning information of the region is not stored locally at the terminal in the second storage area, downloading the positioning information of the region from the server to the terminal; and
wherein obtaining, from the locally stored positioning information of the region stored at the terminal, geographical location information corresponding to the obtained target network identifier comprises:
if the positioning information of the region is stored locally at the terminal in the first storage area, obtaining, from the first storage area, the geographical location information corresponding to the obtained target network identifier; and
if the positioning information of the region is not stored locally at the terminal in the first storage area, obtaining, from the second storage area, the geographical location information corresponding to the obtained target network identifier.

32. The terminal according to claim 31, wherein downloading the positioning information of the region from the server to the terminal comprises: downloading the positioning information of the region from the server to at least one of the second storage area and the first storage area.

33. The terminal according to claim 31, wherein loading the positioning information of the region stored in the second storage area into the first storage area comprises:
determining whether positioning information of a historical region is stored in the first storage area; and
if the positioning information of the historical region is stored, removing the positioning information of the historical region from the first storage area.

34. The terminal according to claim 29, wherein after determining whether the positioning information of the region associated with the obtained target network identifier is stored locally at the terminal, the programming instructions further instruct the one or more hardware processors to:
if the positioning information is stored locally at the terminal and the geographical location information corresponding to the obtained target network identifier is not stored locally at the terminal:
download, from the server to the terminal, the geographical location information corresponding to the obtained target network identifier; and
load the downloaded geographical location information corresponding to the obtained target network identifier into the positioning information.

35. The terminal according to claim 29, wherein the programming instructions further instruct the one or more hardware processors to:
detect that a GPS is enabled;
receive geographical location information from the GPS; and
update the geographical location information corresponding to the obtained target network identifier in the locally stored positioning information with the geographical location information from the GPS.

36. A non-transitory computer-readable storage medium storing computer instructions, when executed by one or more hardware processors of a terminal, cause the one or more hardware processors to perform operations comprising:
obtaining a target network identifier associated with the terminal;
determining, according to the obtained target network identifier, whether positioning information of a region associated with the obtained target network identifier is stored locally at the terminal;
in response to determining that the positioning information of the region is not stored locally at the terminal:
downloading the positioning information of the region from a server to the terminal, wherein the positioning information of the region comprises geographical location information corresponding to multiple network identifiers associated with the region, and wherein the multiple network identifiers are associated with multiple network devices located in the region; and
storing the downloaded positioning information of the region at the terminal; and
in response to receiving a positioning request, obtaining, from the locally stored positioning information of the region stored at the terminal, geographical location information corresponding to the obtained target network identifier.

37. The non-transitory computer-readable medium according to claim 36, wherein determining, according to the obtained target network identifier, whether positioning information of a region associated with the obtained target network identifier is stored locally at the terminal, comprises:
obtaining, from the server, the region associated with the obtained target network identifier; and
determining, according to the obtained region, whether the positioning information of the region is stored locally at the terminal.

38. The non-transitory computer-readable medium according to claim 37, wherein determining, according to the obtained region, whether the positioning information of the region is stored locally at the terminal, comprises:
determining whether the positioning information of the region is stored locally at the terminal in a first storage area;
in response to determining that the positioning information of the region is not stored locally at the terminal in the first storage area:
determining whether the positioning information of the region is stored locally at the terminal in a second storage area;
in response to determining that the positioning information of the region is stored locally at the terminal in the second storage area, loading the positioning information of the region stored in the second storage area into the first storage area; and
in response to determining that the positioning information of the region is not stored locally at the terminal in the second storage area, downloading the positioning information of the region from the server to the terminal; and
wherein obtaining, from the locally stored positioning information of the region stored at the terminal, geographical location information corresponding to the obtained target network identifier comprises:
if the positioning information of the region is stored locally at the terminal in the first storage area, obtaining, from the first storage area, the geographical location information corresponding to the obtained target network identifier; and
if the positioning information of the region is not stored locally at the terminal in the first storage area, obtaining, from the second storage area, the geographical location information corresponding to the obtained target network identifier.

39. The non-transitory computer-readable medium according to claim 38, wherein downloading the positioning information of the region from the server to the terminal comprises: downloading the positioning information of the region from the server to at least one of the second storage area and the first storage area.

40. The non-transitory computer-readable medium according to claim 38, wherein loading the positioning information of the region stored in the second storage area into the first storage area comprises:
determining whether positioning information of a historical region is stored in the first storage area; and
if the positioning information of the historical region is stored, remove the positioning information of the historical region from the first storage area.

41. The non-transitory computer-readable medium according to claim 36, wherein after determining whether positioning information of a region associated with the obtained target network identifier is stored locally at the terminal, the operations further comprises:
if the positioning information is stored locally at the terminal and the geographical location information corresponding to the obtained target network identifier is not stored locally at the terminal:
downloading, from the server to the terminal, the geographical location information corresponding to the obtained target network identifier; and
loading the downloaded geographical location information corresponding to the obtained target network identifier into the positioning information.
